(19) United States
(12) Patent Application Publication
(10) Pub. No.: US 2025/0286272 A1
(43) Pub. Date: Sep. 11, 2025

(54) FREQUENCY SELECTIVE STRUCTURE WITH ARTIFICIAL DIELECTRIC MATCHING ELEMENTS

(71) Applicant: BAE Systems Space & Mission Systems Inc., Broomfield, CO (US)

(72) Inventor: Joshua Thomas Miers, Arvada, CO (US)

(73) Assignee: BAE Systems Space & Mission Systems Inc., Broomfield, CO (US)

(21) Appl. No.: 19/068,669

(22) Filed: Mar. 3, 2025

Related U.S. Application Data
(60) Provisional application No. 63/563,501, filed on Mar. 11, 2024.

(51) Int. Cl. H01Q 1/42

(52) U.S. Cl. CPC H01Q 1/422

(57) ABSTRACT

A frequency selective structure featuring one or more layers of artificial dielectric matching elements. The artificial dielectric matching elements have an open distal end and a closed base end. The closed base end of each artificial dielectric matching element is disposed on or adjacent to a first surface of a substrate. Artificial dielectric matching elements can also be disposed on or adjacent a second surface of the substrate. The substrate can be configured as a frequency selective surface. The artificial dielectric matching elements can have interior volumes that are wider adjacent to the open distal end, and narrower adjacent to the closed base end. Any non-conductive material can be used to form the artificial dielectric matching elements. The artificial dielectric matching elements can be placed using automated pick and place operations.

### CROSS-REFERENCE TO RELATED APPLICATION

This application claims the benefit of U.S. Provisional Patent Application Ser. No. 63/563,501, filed Mar. 11, 2024, the entire disclosure of which is hereby incorporated herein by reference.

### FIELD

Systems and methods for providing a frequency selective surface or structure incorporating an artificial dielectric that enables the transmission of electromagnetic waves within a selected range of frequencies through a structure at a wide range of relative angles are provided.

### BACKGROUND

Antennas are often used in environments in which it is desirable to provide a cover or radome to protect the antenna and to provide a surface that conforms to the vehicle or other structure to which the antenna is interconnected. In addition to providing adequate structural integrity and durability for a given set of operating conditions, a radome must be transparent to electromagnetic energy within the intended operating wavelengths of the associated antenna. In addition, it can be desirable to provide a radome that rejects wavelengths outside of the intended operating range. Moreover, it can be desirable to provide a radome that provides selected wavelength transparency to signals having multiple polarizations. In order to provide such characteristics, a radome often incorporates a frequency selective surface.

A frequency selective surface is a type of structure that passes electromagnetic energy within a selected wavelength range and that stops or blocks electromagnetic energy outside of that selected wavelength range. Although such structures can be designed with great precision with respect to signals that are normal (or at some other predetermined angle) to the surface of the structure, the effective passband presented to the electromagnetic energy changes with the angle of incidence. Accordingly, the performance of an antenna can be compromised along certain relative lines of sight by a radome that features curves or where the antenna covered by the radome is mechanically or electronically scanned. The adverse effects of a radome on antenna performance can in some cases be reduced by providing additional layers of material adjacent to the frequency selective surface. In particular, the inclusion of layers of relatively low dielectric constant material can extend the range of angles over which a desired wavelength response is obtained. However, it can be difficult or impossible to obtain a material having the required dielectric constant. In addition, materials having low dielectric constants are often foams or other porous, mechanically weak materials. Such materials can also be prone to absorbing water and other atmospheric constituents, and can have coefficients of thermal expansion that are not well matched to that of other materials in the structure.

Accordingly, it would be desirable to provide a frequency selective structure that enabled selected transmission characteristics to electromagnetic energy of any polarization over a wide range of angles, and that could be constructed without requiring materials having relatively low dielectric constants.

### SUMMARY

Embodiments of the present disclosure are directed to providing frequency selective structures with favorable transmission characteristics with respect to radio frequency energy over a range of incident angles. A frequency selective structure as disclosed herein generally includes a substrate and one or more artificial dielectric matching layers that each include an array of artificial dielectric matching elements. The artificial dielectric matching elements can be formed from a dielectric material and can be configured as cylinders or faceted elements with a closed base end adjacent the substrate and an open distal end opposite the base end, where adjacent is close to or on. An interior volume of each artificial dielectric matching element can include more than one interior volume portion. For example, a first interior volume portion having a first diameter can be disposed adjacent the base, and a second interior volume portion having a second diameter, where the second diameter is larger than the first diameter, can be disposed adjacent the open distal end. A coating can be disposed over the artificial dielectric matching elements, filling the interior volumes and the spaces between adjacent elements, to form a smooth surface.

In accordance with at least some embodiments of the present disclosure, a frequency selective structure can include a frequency selective surface. For instance, a frequency selective surface can be disposed between the substrate and an artificial dielectric matching layer having an array of artificial dielectric matching elements. As another example, the substrate can be configured as a thick frequency selective surface, with through holes in which paired artificial dielectric matching elements are received.

Frequency selective structures in accordance with embodiments of the present disclosure provide selected wavelength transparency to electromagnetic energy over a wide range of angles. In addition, the frequency selective structures can provide selected wavelength transparency to electromagnetic energy having any of multiple different polarizations.

Additional features and advantages of embodiments of the present disclosure will become more readily apparent from the following description, particularly when taken together with the accompanying drawings.

### BRIEF DESCRIPTION OF THE DRAWINGS

FIGS. 1A and 1B illustrate example antennas and associated radomes that incorporate a frequency selective structure in accordance with embodiments of the present disclosure;

FIG. 2 is a cross section in elevation of a frequency selective structure incorporating a frequency selective surface in accordance with the prior art;

FIG. 3 is a plan view of a frequency selective structure incorporating a frequency selective surface in accordance with the prior art;

FIG. 4 is a graph depicting the transmission performance of an example frequency selective structure in accordance with the prior art;

FIG. 5 is a cross section in elevation of a frequency selective structure incorporating a frequency selective surface and dielectric matching layers in accordance with the prior art;

FIG. 6A is a cross section in elevation of a frequency selective structure incorporating a frequency selective surface and artificial dielectric matching elements in accordance with embodiments of the present disclosure;

FIG. 6B is a cross section in elevation of a frequency selective structure incorporating a frequency selective surface and artificial dielectric matching elements in accordance with other embodiments of the present disclosure;

FIG. 7 is a plan view of a frequency selective structure incorporating artificial dielectric matching elements in accordance with embodiments of the present disclosure;

FIG. 8 is a plan view of a frequency selective surface of a frequency selective structure in accordance with embodiments of the present disclosure;

FIG. 9 is a cross-section in elevation of an artificial dielectric matching element in accordance with embodiments of the present disclosure;

FIG. 10 is a top plan view of an artificial dielectric matching element in accordance with embodiments of the present disclosure;

FIG. 11A is a cross section in elevation of a unitary frequency selective structure incorporating artificial dielectric matching elements in accordance with embodiments of the present disclosure;

FIG. 11B is a cross section in elevation of a unitary frequency selective structure incorporating artificial dielectric matching elements in accordance with other embodiments of the present disclosure;

FIG. 12 is a plan view of a unitary frequency selective structure incorporating artificial dielectric matching elements in accordance with embodiments of the present disclosure;

FIG. 13A is a cross section in elevation of a frequency selective structure incorporating a thick frequency selective surface and artificial dielectric matching elements in accordance with embodiments of the present disclosure;

FIG. 13B is a cross section in elevation of a frequency selective structure incorporating a thick frequency selective surface and artificial dielectric matching elements in accordance with other embodiments of the present disclosure;

FIG. 14 is a plan view of a frequency selective structure incorporating a thick frequency selective surface and artificial dielectric matching elements in accordance with embodiments of the present disclosure;

FIG. 15 is a graph depicting the transmission performance of a frequency selective structure incorporating artificial dielectric matching elements in accordance with embodiments of the present disclosure; and

FIG. 16 is a flow chart illustrating aspects of a method for forming a frequency selective structure incorporating an artificial dielectric matching layer having a plurality of artificial dielectric matching elements in accordance with embodiments of the present disclosure.

### DETAILED DESCRIPTION

Embodiments of the present disclosure are generally directed to providing frequency selective structures that provide selected transmission characteristics for electromagnetic energy or waves over a wide range of angles. More particularly, embodiments of the present disclosure are directed to frequency selective structures that incorporate an artificial dielectric matching layer having an array of artificial dielectric matching structures or elements to provide desired transmission characteristics over a wide range of angles. In accordance with further embodiments of the present disclosure, frequency selective structures are provided that attenuate or block electromagnetic energy within a selected stop band over a wide range of angles. In accordance with still further embodiments, a frequency selective structure incorporating an artificial dielectric matching layer comprising a plurality of artificial dielectric matching elements as disclosed herein provides desired transmission characteristics to electromagnetic energy having any of multiple different polarization states. Frequency selective structures as disclosed herein are particularly well suited for use in radomes or antenna covers, or on any other structure disposed directly adjacent or near a transmitting or receiving antenna element for which specified electromagnetic energy transmission characteristics are desired or required.

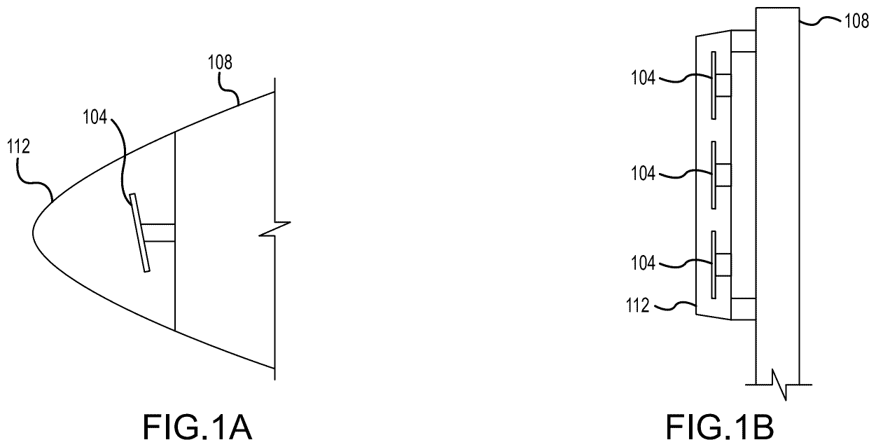

FIGS. 1A and 1B illustrate example antennas and associated radomes that incorporate a frequency selective structure in accordance with embodiments of the present disclosure. In FIG. 1A, an antenna 104, such as a weather radar, target acquisition radar, or radio communication antenna disposed on a structure 108, in this example an aircraft, is depicted. The antenna 104 is disposed within an interior volume of an antenna cover or radome 112, shown in cross-section in the figure. The radome 112 can form part of the aerodynamic structure of the aircraft, and serves to protect the antenna 104 from the surrounding environment. In FIG. 1B, a plurality of antennas 104, such as a set of cellular telephony antennas interconnected to a structure 108, in this example a cellular telephone tower, are depicted. The antennas 104 are disposed within an interior volume of an antenna cover or radome 112, shown in cross-section in the figure, which provides protection for the antennas 104 from the surrounding environment. As can be appreciated by one of skill in the art, it is generally desirable to provide a radome 112 that allows the operating frequencies of an associated antenna 104 to pass through the radome 112 without attenuation or other modification of a transmitted or received signal. In addition, it can be desirable to provide a radome 112 that blocks radio frequency energy within selected other frequency ranges. Accordingly, an antenna cover or radome 112 is typically configured as a frequency selective structure. However, providing a radome 112 that provides desired transmission characteristics to radio frequency energy that is incident on a surface of the radome 112 at different angles, for example because the radome 112 is curved or because a beam is mechanically or electronically scanned, has been difficult.

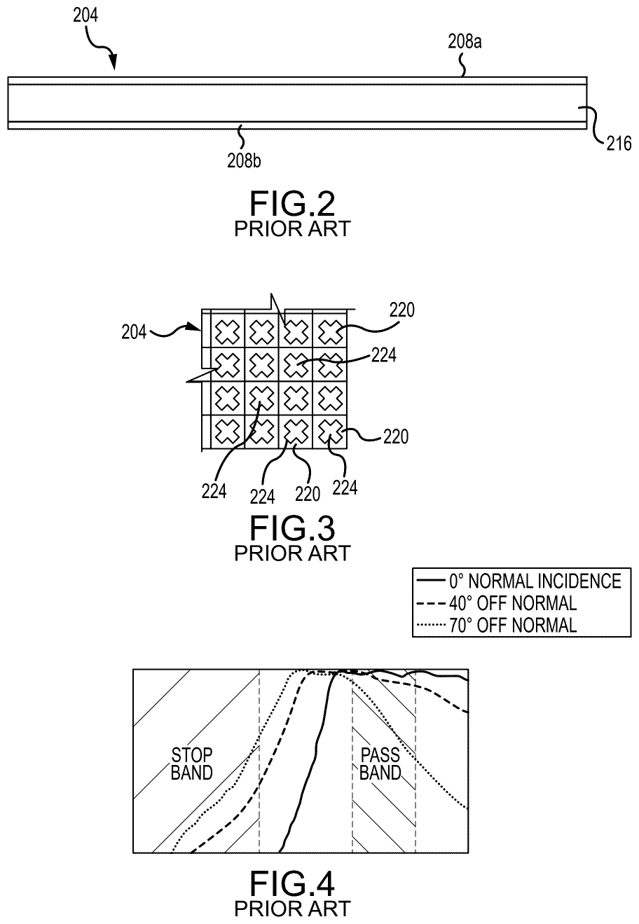

FIG. 2 is a cross section in elevation and FIG. 3 is a plan view of a basic frequency selective structure 204 in accordance with the prior art. The frequency selective structure 204 can include first 208a and second 208b frequency selective surfaces or layers spaced apart from one another by a dielectric layer 216. The frequency selective surfaces 208 are resonant repeating structures that are disposed directly on opposite surfaces of the dielectric layer 216. The dielectric layer 216 can be formed from a material having a relatively low dielectric constant. The thickness of the dielectric layer 216, and thus the spacing between the two frequency selective surfaces 208a and 208b, can be some fraction of a wavelength of a signal to be passed by the frequency selective structure 204. The frequency selective surfaces 208a and 208b can be configured identically, and can each include an electrically conductive material having a plurality of unit cells 220 disposed in an array, with each unit cell 220 containing a slot element 224 formed as an open or nonconductive area (see FIG. 3). The size and configuration of the slot elements 224 of the unit cells 220 is dependent on the desired transmission characteristics of the frequency selective structure 204.

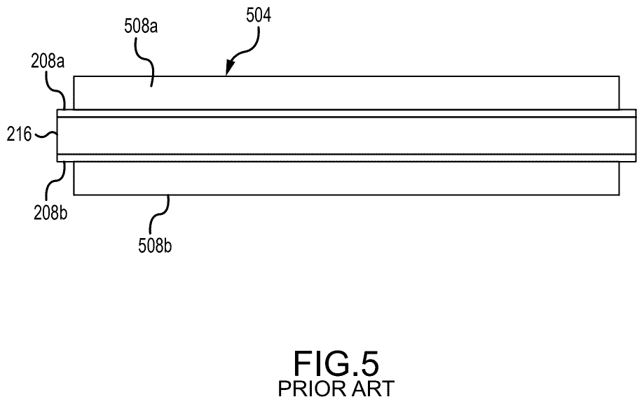

As illustrated in FIG. 4, the transmission performance of a frequency selective structure 204 with respect to electromagnetic energy at a normal angle to the frequency selective structure 204 is not well aligned with the transmission performance of the frequency selective structure 204 with respect to electromagnetic energy at non-normal angles. Accordingly, it is difficult to provide a frequency selective structure 204 that provides transparency to electromagnetic energy having a wavelength within a selected band while rejecting electromagnetic energy at wavelengths outside of that selected band over a wide range of angles.

In order to improve the off normal performance of a basic prior art frequency selective structure 204, and as illustrated in FIG. 5, a modified frequency selective structure 504 can include additional layers of dielectric material layers 508a and 508b disposed on either side of the basic frequency selective structure 204. For instance, the dielectric material layers 508 can be disposed directly on surfaces of the frequency selective surfaces 208 of the basic frequency selective structure 204. Provided each of the additional layers of dielectric material 508 feature a low dielectric constant (e.g. about 1.2), the modified frequency selective structure 504 can exhibit transmission performance that is relatively consistent over a range of angles. Accordingly, the normal angle and off-normal angle performance of the modified frequency selective structure 504 can be improved as compared to that of the basic frequency selective structure 204. However, it can be difficult to identify a material with the required dielectric constant. Moreover, materials exhibiting a sufficiently low dielectric constant are often foams or other porous materials that can have poor structural characteristics and that can absorb moisture or other atmospheric constituents.

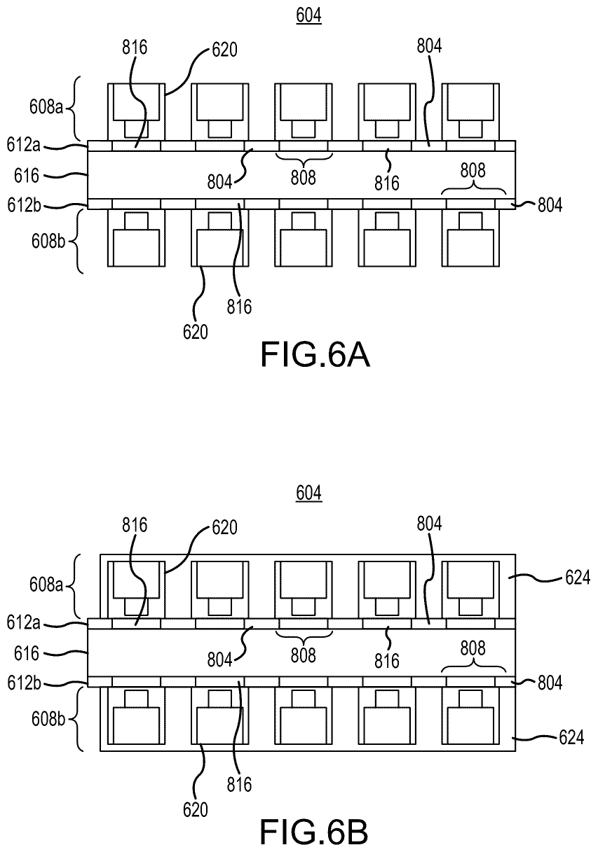

A cross-section in elevation of a portion of a frequency selective structure 604 in accordance with embodiments of the present disclosure is depicted in FIG. 6A. The frequency selective structure 604 features one or more artificial dielectric matching layers 608 as disclosed herein. In accordance with at least some embodiments, the frequency selective structure 604 includes first 612a and second 612b frequency selective surface layers spaced apart from one another by a substrate 616. In this example, the substrate 616 is a dielectric layer. The thickness of the substrate 616, and thus the distance between the first 612a and second 612b frequency selective surface layers, is a fraction of a wavelength to which the frequency selective structure 604 is transparent. In addition, the size and spacing of the unit cells 808 (see FIGS. 6A and 8) of the frequency selective surface layers 612 can be based on the desired transmission performance of the frequency selective structure 604, and can be determined using the same or similar techniques as would be used to design a basic 204 or modified 504 frequency selective structure of the prior art. Accordingly, certain elements of a frequency selective structure 604 can have a configuration that is the same as or similar to the basic prior art frequency selective structure 204 illustrated in FIGS. 2 and 3 and the modified frequency selective structure 504 illustrated in FIG. 5. However, rather than including the layers 508 of low dielectric material as in the modified frequency selective structure 504, a frequency selective structure 604 in accordance with embodiments of the present disclosure includes one or more of artificial dielectric matching layers 608.

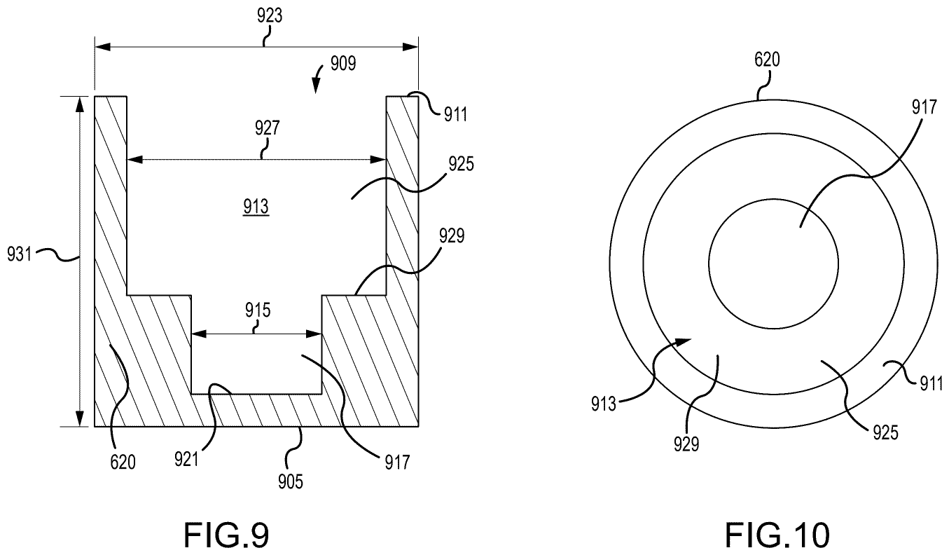

As shown in FIG. 6A, a first artificial dielectric matching layer 608a that includes a first set of artificial dielectric matching elements 620 is disposed on or adjacent a surface of the first frequency selective surface layer 612a, and a second artificial dielectric matching layer 608b that includes a second set of artificial dielectric matching elements 620 is disposed on or adjacent a surface of the second frequency selective surface layer 612b. The artificial dielectric matching elements 620 included in the artificial dielectric matching layers 608 can be disposed directly on or adjacent to a corresponding one of the frequency selective surface layers 612. Accordingly, the artificial dielectric matching layers 608 can form the outer layers of the frequency selective structure 604. In accordance with further embodiments of the present disclosure, and as illustrated in FIG. 6B, which is otherwise the same as the embodiment illustrated in FIG. 6A, the frequency selective structure 604 can also include a coating 624 that covers the artificial dielectric matching elements 620 of one or both of the artificial dielectric matching layers 608, filling the spaces between the artificial dielectric matching elements 620 and interior volumes 913 (see FIG. 9) of the artificial dielectric matching elements 620, thereby creating a smooth surface. The coating 624 can include a dielectric material. As an example, but without limitation, the coating 624 can include a low density ablator or insulator in the form of a filled elastomeric silicone commonly used for thermal protection on aircraft. The coating 624 can also be in the form of a white silicon based paint or thick film coating or an epoxy coating.

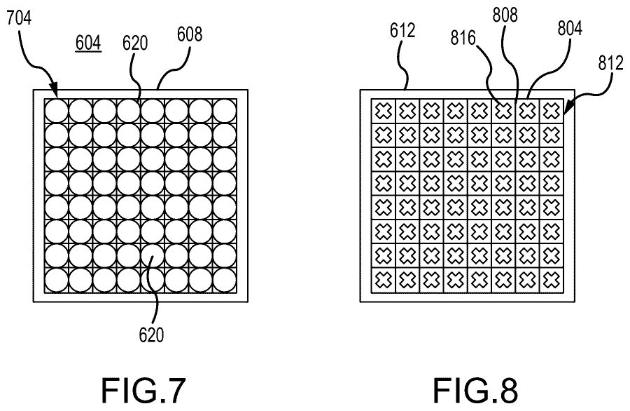

As previously noted, each artificial dielectric matching layer 608 includes a plurality of artificial dielectric matching elements 620. As illustrated in FIG. 7, which is a plan view of a frequency selective structure 604 in accordance with embodiments of the present disclosure, the artificial dielectric matching elements 620 in an artificial dielectric matching layer 608a or 608b (labeled simply as 608 in FIG. 7) can be disposed in an array 704. The array can be a two dimensional array or lattice. For instance, as depicted in FIG. 7, the lattice can be a rectangular lattice. However, other patterns or dispositions are possible. For instance, the lattice can be a hexagonal lattice. In addition, the artificial dielectric matching elements 620 within an artificial dielectric matching layer 608 can all have the same composition and size, and can be equally spaced from one another. The spacing and configuration of the artificial dielectric matching elements 620 in an artificial dielectric matching layer 608 can correspond to the spacing and configuration of the unit cells 808 of the immediately adjacent frequency selective surface layer 612 (see FIGS. 6A, 6B, and 8). For instance, the artificial dielectric matching elements 620 and the unit cells 808 can be disposed in matching two-dimensional arrays, such that each artificial dielectric matching element 620 is within an area of a corresponding unit cell 808. In accordance with embodiments of the present disclosure, the spacing and configuration of the arrays of artificial dielectric matching elements 620 of the artificial dielectric matching layers 608 within a frequency selective structure 604 can be the same or different from one another.

FIG. 8 is a plan view of a frequency selective surface layer 612 of a frequency selective structure 604 in accordance with embodiments of the present disclosure. The frequency selective surface layer 612 can be configured as an electrically conductive material 804 having a plurality of unit cells 808 disposed in an array 812. Each of the unit cells 808 includes a slot element 816, formed as an open or otherwise nonconductive area in the conductive material 804. The size and shape of the slot elements 816 in the individual unit cells 808, and the spacing between the unit cells 808 of the array 812, can be determined based on the desired passband and stop band characteristics of the frequency selective structure 604.

In accordance with embodiments of the present disclosure, each artificial dielectric matching element 620 of an artificial dielectric matching layer 608 is associated with a corresponding unit cell 808 of an immediately adjacent frequency selective surface layer 612. Moreover, each artificial dielectric matching element 620 is disposed on or adjacent a side of a frequency selective surface layer 612 opposite the side of that frequency selective surface layer 612 that is on or facing the substrate 616. For example, each artificial dielectric matching element 620 can be disposed in an area corresponding to an area of a unit cell 808 of the frequency selective surface layer 612. An exterior diameter of the dielectric matching elements 620 can be less than a width or length of the unit cells 808. In accordance with at least some embodiments of the present disclosure, each artificial dielectric matching element 620 is centered within an area of a corresponding unit cell 808. Therefore, comparing the array 704 of artificial dielectric matching elements 620 illustrated in FIG. 7 to the array 812 of unit cells 808 illustrated in FIG. 8, it can be seen that the configuration and spacing of the artificial dielectric matching elements 620 matches that of the unit cells 808. As an example, both the artificial dielectric matching elements 620 and the unit cells 808 can be disposed in an array in the form of a regular lattice.

FIG. 9 is a cross-section in elevation of an artificial dielectric matching element 620 and FIG. 10 is a top plan view of an artificial dielectric matching element 620 in accordance with embodiments of the present disclosure. In FIG. 9, only surfaces along the section are shown for clarity. As illustrated, each artificial dielectric matching element 620 can be configured as a cylindrical element with a closed base portion 905 that is adjacent or directly on a corresponding unit cell 808, and an open end or distal portion 909 opposite the base portion 905. Accordingly, in a frequency selective structure 604 as described herein, an artificial dielectric matching element 620 has an interior void or volume 913 that extends between an open end 909, which faces away from an adjacent frequency selective surface layer 612, and a closed end 921 at or coincident with the base portion 905. In accordance with at least some embodiments of the present disclosure, an exterior diameter 923 of the artificial dielectric matching element 620 is constant along a length of the element 620, from the base portion 905 to the end 909 opposite to the base portion. In addition, a diameter of the interior volume 913 can be different at different distances from the closed base portion 905. Accordingly, an artificial dielectric matching element 620 can include multiple interior volume portions corresponding to areas within the interior volume 913 having different interior diameters.

For instance, and as illustrated in FIGS. 9 and 10, a first interior volume portion 917 of the interior volume 913 having a first diameter 915 is disposed adjacent the closed end 921 of the interior volume 913, and a second interior volume portion 925 having a second diameter 927, where the second diameter is larger than the first diameter, is disposed between a shoulder surface 929, formed at the interface of the first diameter 915 and second diameter 927 portions, and the open end 909. Accordingly, the first interior volume portion 917 and the second interior volume portion 925 can be in the form of cylindrical volumes that are concentric with one another and with the exterior diameter 923 of the artificial dielectric matching element 620. Although an example with two interior volume portions 917 and 925 has been illustrated, it should be appreciated that an artificial dielectric matching element 620 Is not limited to any particular number of interior volume portions. In accordance with other embodiments of the present disclosure, an artificial dielectric matching element 620 can include an interior volume or void 913 with a single, constant diameter interior volume portion. In accordance with still other embodiments of the present disclosure, the interior volume 913 of an artificial dielectric matching element 620 can have a diameter that increases with distance from the base portion 905. Where the diameter of the interior volume 913 increases with distance from the base portion 905, the increase can be linear, exponential, stepped, or according to some other function. Artificial dielectric matching elements 620 in accordance with still further embodiments of the present disclosure can also include faceted outer surfaces and/or a faceted interior volumes 913. As can be appreciated by one of skill in the art after consideration of the present disclosure, an artificial dielectric matching element 620 can therefore include more dielectric material at or near the base portion 905 than at the open distal portion or end 909. Moreover, the exterior diameter 923 can remain constant, with the effect that the walls of the artificial dielectric matching elements are thinner at the open end 909 than adjacent the base 905.

In accordance with embodiments of the present disclosure, the artificial dielectric matching elements 620 can be formed from any insulator. Examples of suitable materials include standard circuit board materials, glass, fused silica, and ceramics. Moreover, the material from which the dielectric matching elements 620 are formed need not have a particularly low dielectric constant. As such, the material of the artificial dielectric matching elements 620 can have a dielectric constant of anywhere from 1.3 to 9.0. As a further example, the material of the artificial dielectric matching elements 620 can have a dielectric constant of from 1.4 to 4.0.

The size of the artificial dielectric matching elements 620, the size of the interior volume 913 and the sizes of any included interior volume portions 917 or 925 can be tuned to match the low angle response of the resulting frequency selective structure 604 to the normal angle response of that structure 604. As examples, but without limitation, the diameter 923 of the exterior cylindrical surface of each artificial dielectric matching element 620 can be about one-half a wavelength of a selected signal (and the size of each slot element 816 of the frequency selective surface layer 612 can likewise be about one-half a wavelength of the selected signal). The height 931 of the artificial dielectric matching element 620, from the base 905 to a top or distal edge 911, can be between one-quarter and one-half a wavelength of the selected signal. The first interior volume portion 917 can have a diameter that is between 50% and 70% of the outer diameter 923 of the artificial dielectric matching element 620 and can extend to a point that is about 90% of a distance from the open distal end 909 to an outer surface of the base portion 905. The second interior volume portion 925 can have a diameter that is between 75% and 95% of the outer diameter 923 of the artificial dielectric matching element 620 and can extend from the open distal end 909 to about 60% of the way to the base portion 905.

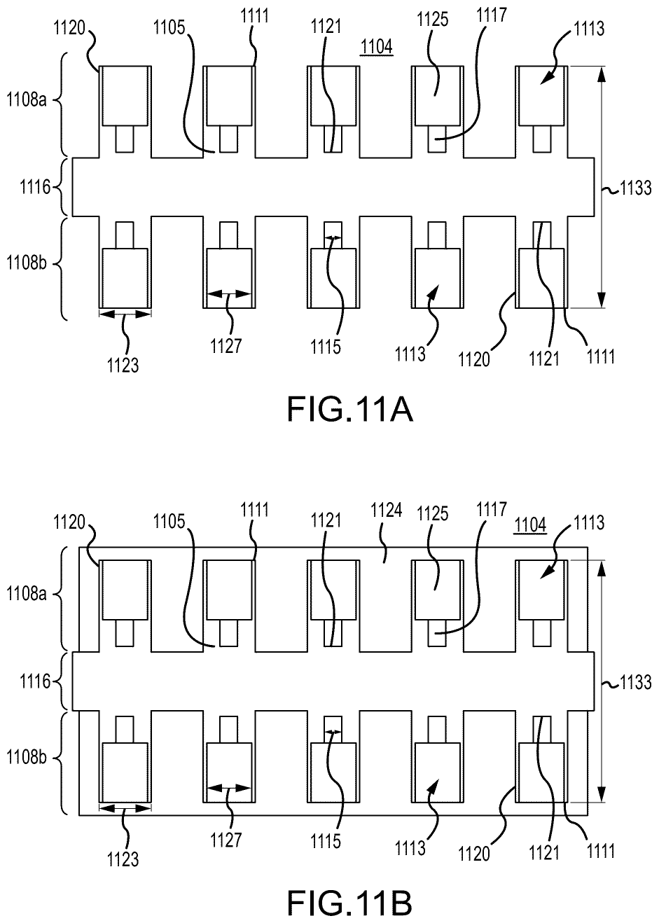

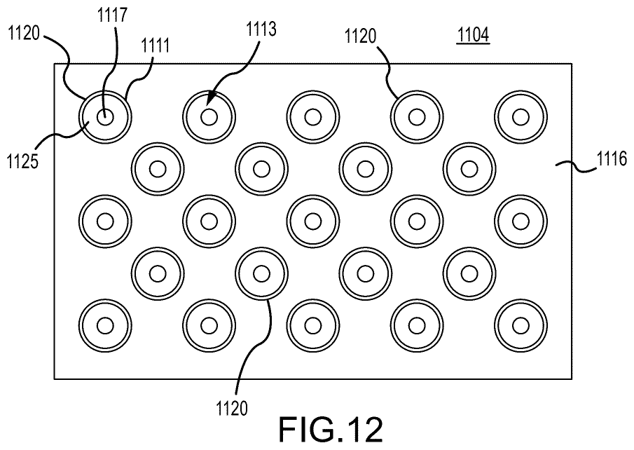

FIG. 11A is a cross section in elevation and FIG. 12 is a plan view of a one-piece or unitary frequency selective structure 1104 incorporating artificial dielectric matching layers 1108 that each include an array of artificial dielectric matching elements 1120 that are integral to a substrate 1116 in accordance with embodiments of the present disclosure. More particularly, the artificial dielectric matching elements 1120 and the substrate 1116 are formed from the same piece of material. The material may have a dielectric constant ranging from 1.3 to 9.0. As an example, the unitary frequency selective structure 1104 can be molded from a plastic polycarbonate. As another example, the unitary frequency selective structure 1104 can be three-dimensional printed using polylactic acid (PLA) or acrylonitrile butadiene styrene (ABS). As illustrated in FIG. 11B, which is otherwise the same as FIG. 11A, a coating 1124 can be applied over the artificial dielectric matching elements 1120 of one or both of the artificial dielectric matching layers 1108a and 1108b, filling the interior volumes 1113 of the artificial dielectric matching elements 1120 and the spaces between neighboring artificial dielectric matching elements 1120, creating a smooth surface. As in other embodiments, examples of the coating 1124 can include a dielectric material such as a low density ablator or insulator in the form of a filled elastomeric silicone, a white silicon based paint, a thick film coating, or an epoxy coating.

In the embodiments of FIGS. 11A, 11B, and 12, a metallized frequency selective surface is not included. Accordingly, in a unitary frequency selective structure 1104 as disclosed herein, the size, configuration and spacing of the artificial dielectric matching elements 1120, together with the material selected to form the structure 1104, enables selected performance characteristics to be obtained. The artificial dielectric matching elements 1120 included in a unitary frequency selective structure 1104 as disclosed herein can include a base portion 1105 defining a closed end 1121 of an interior volume 1113, a first interior volume portion 1117 having a first diameter 1115, and a second interior volume portion 1125 having a second diameter 1127 that is larger than the first diameter 1115. The material selected for forming the unitary frequency selective structure 1104, the dimensions of the artificial dielectric matching elements 1120, the spacing of the artificial dielectric matching elements 1120, the form of the array or other pattern according to which the artificial dielectric matching elements 1120 are disposed across the substrate 1116, and the thickness of the substrate 1116 can all be selected in consideration of the frequencies at which the transmission of radio frequency signals are desired, the range of angles at which the radio frequency signals will intersect a radome 112 or other structure incorporating the unitary frequency selective structure 1104, and desired protection against electromagnetic interference.

As an example, but without limitation, a unitary frequency selective structure 1104 can be injection molded from a polycarbonate having a dielectric constant of 3.85. The area of the unitary frequency selective structure 1104 constituting the substrate 1116 can have a thickness of about 0.6 inch. A distance 1133 from an end 1111 of a first artificial dielectric matching element 1120 on a first side of the substrate 1116 to an end 1111 of a second artificial dielectric matching element 1120 on a second side of the substrate 1116 and aligned with the first artificial dielectric matching element 1120 may be about 1.6 inches. An exterior diameter 1123 of the artificial dielectric matching elements 1120 may be about 0.355 inches.

A unitary frequency selective structure 1104 as disclosed herein allows the construction of a radome 112 or other structure having excellent transmission performance with respect to radio frequency energy within a selected band of frequencies, and over a range of angles. The performance of the unitary frequency selective structure 1104 may differ from that of embodiments including one or more frequency selective surfaces. For example, the range of angles over which radio frequency losses remain low may be reduced as compared to embodiments incorporating a frequency selective surface. This narrowing of the angular range over which the unitary frequency selective structure 1104 is essentially transparent to radio frequency energy may be more apparent for a particular polarization than for another polarization. As a further example, the rejection of selected wavelengths by a unitary frequency selective structure 1104 may be diminished as compared to embodiments incorporating a frequency selective structure.

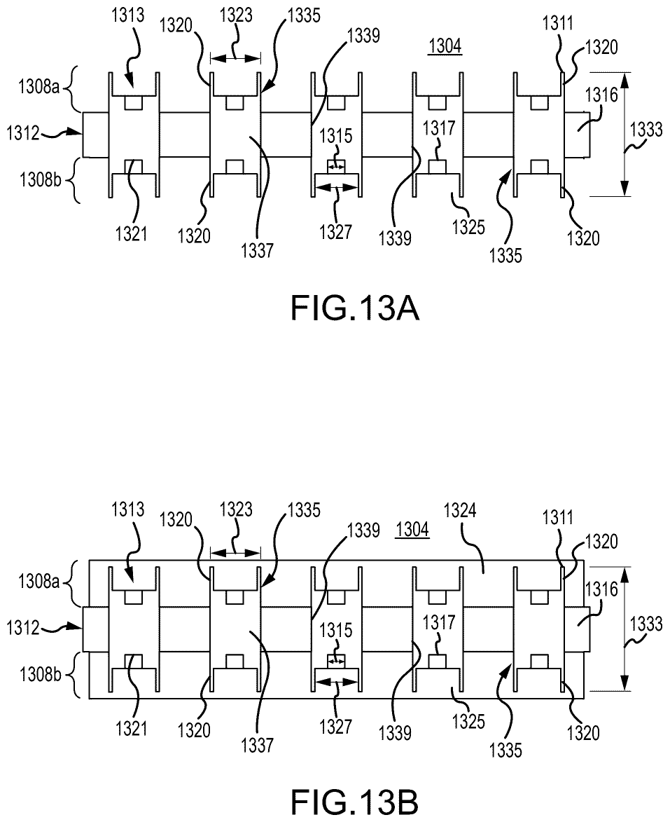

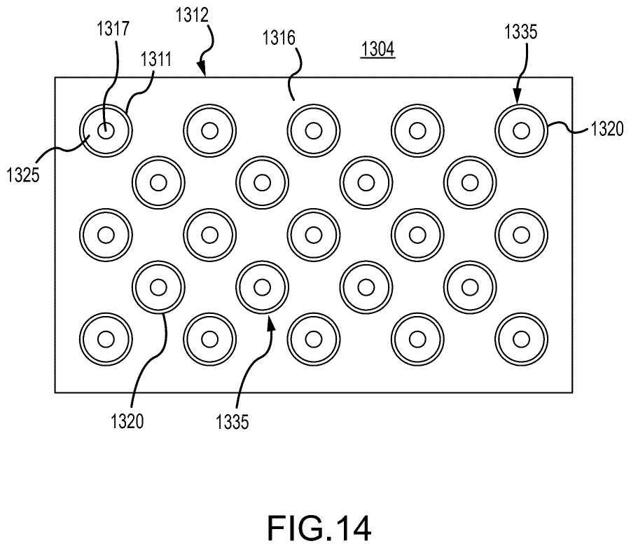

FIG. 13A is a cross section in elevation and FIG. 14 is a plan view of a frequency selective structure 1304 incorporating a substrate 1316 in the form of a thick frequency selective surface 1312. In the frequency selective structure 1304, a pair of artificial dielectric matching layers 1308a and 1308b are formed by a shared set of artificial dielectric matching components 1335. Each of the artificial dielectric matching components 1335 includes a pair of artificial dielectric matching elements 1320 disposed on opposite sides of a connecting section 1337. In accordance with at least some embodiments of the present disclosure, the artificial dielectric matching elements 1320 and the connecting section 1337 of any one of the artificial dielectric matching components 1335 are integrally formed from the same piece of material. The thick frequency selective surface 1312 can be configured as a plate or substrate 1316 of electrically conductive material with an array of through holes or apertures 1339 formed therein. The thickness and other parameters of the thick frequency selective surface 1312 can be determined using the same or similar techniques as would be used to design a conventional thick frequency selective surface.

The thick frequency selective surface 1312 of embodiments of the present disclosure is different from a conventional thick frequency selective surface in that artificial dielectric matching components 1335 as disclosed herein are disposed within the through holes 1339. In accordance with embodiments of the present disclosure, the connecting section 1337 of each artificial dielectric matching component 1335 is centered in the thick frequency selective surface 1312, with a first one of the artificial dielectric matching elements 1320 disposed on a first surface side of the thick frequency selective surface 1312, and a second one of the artificial dielectric matching elements 1320 disposed on a second surface side of the thick frequency selective surface 1312. The artificial dielectric matching elements 1320 included in an artificial dielectric matching component 1335 can be identical to one another, and can include a base portion 1305 extending from the connecting section 1337 and defining a closed end 1321 of an interior volume 1313, a first interior volume portion 1317 having a first diameter 1315, and a second interior volume portion 1325 having a second diameter 1327 that is larger than the first diameter 1315. As an example, but without limitation, the material of an artificial dielectric matching component 1335 can be a glass, such as a borosilicate glass having a dielectric constant of 4.4. As illustrated in FIG. 13B, a coating 1324 can be applied over the artificial dielectric matching elements 1320 of one or both artificial dielectric matching layers 1308, filling the interior volumes 1313 of and the spaces between the artificial dielectric matching elements 1320, to form a smooth outer surface. As in other embodiments, examples of the coating 1324 can include a dielectric material such as a low density ablator or insulator in the form of a filled elastomeric silicone, a white silicon based paint, a thick film coating, or an epoxy coating.

In accordance with embodiments of the present disclosure, the through holes 1306 can be formed by drilling holes in a plate of electrically conductive material provided as the substrate 1316 having a diameter matching an exterior diameter 1323 of the artificial dielectric matching components 1335. The artificial dielectric matching components 1335 can be formed by molding a glass or other dielectric material. As an example, but without limitation, the thick frequency selective surface 1312 can have a thickness of about 0.111 inches. A distance 1333 from an end 1311 of the first artificial dielectric matching element 1320 of an artificial dielectric matching component 1335 to an end 1311 of the second artificial dielectric matching element 1320 of the artificial dielectric matching component 1335 can be about 0.340 inches. An exterior diameter 1323 of the artificial dielectric matching elements 1320 may be about 0.1088 inches. The diameter of the connecting section 1337 of an artificial dielectric matching component 1335 can be the same as the exterior diameter 1323 of each of the artificial dielectric matching elements 1320 of that artificial dielectric matching component 1335. The diameter 1315 of the first interior volume portion 1317 may be about 0.0032 inches, and the diameter 1327 of the second interior volume portion 1325 may be about 0.0878 inches.

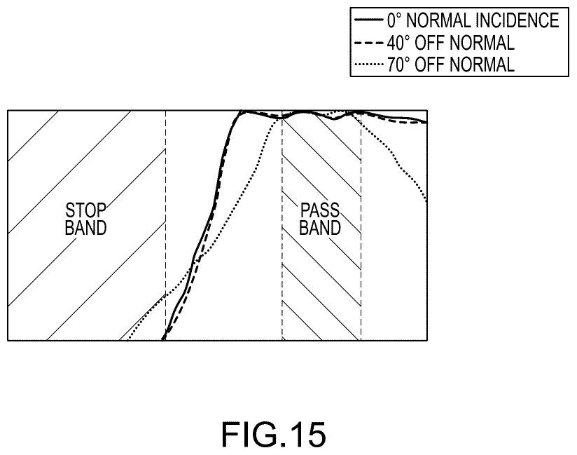

FIG. 15 is a graph depicting the transmission performance of a frequency selective structure 604, 1104, or 1304 incorporating artificial dielectric matching layers 608, 1108, or 1308 in accordance with embodiments of the present disclosure. As depicted, the normal pass band performance and the normal stop band performance of the frequency selective structure 604, 1104, or 1304 can be well aligned with the off-normal pass band performance and the off-normal stop band performance of the frequency selective structure 604, 1104, or 1304.

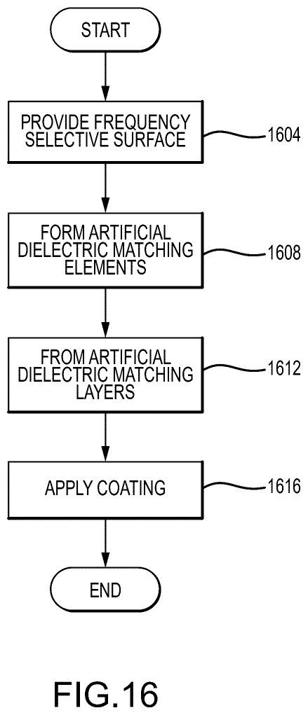

FIG. 16 is a flow chart illustrating aspects of a method for forming a frequency selective structure 604 or 1304 incorporating artificial dielectric matching layers 608 or 1308 and a frequency selective surface layer 612 or 1312 in accordance with embodiments of the present disclosure. Initially, a frequency selective surface layer or surface layers 612, or a thick frequency selective surface 1312, is provided (step 1604). The frequency selective surface layer or layers 612 or the thick frequency selective surface 1312 can configured to provide desired pass band and stop band characteristics for a selected radio frequency or range of radio frequencies. The frequency selective surface layers 612 or 1312 can be designed using conventional techniques. Accordingly, a pair of frequency selective surface layers 612 can be produced as arrays 812 of open or non-conductive slots 816 disposed in unit cells 808 incorporating a metalized or otherwise conductive layer that are disposed on opposite surfaces of a substrate 616 in the form of a layer of dielectric material. A thick frequency selective surface 1312 can be produced by forming an array of through holes or apertures 1339 in a substrate 1316 in the form of a plate of conductive material.

Next, artificial dielectric matching elements 620 or 1320 are formed (step 1608). The artificial dielectric matching elements 620 or 1320 can be configured as cylindrical structures formed from a dielectric material. In embodiments in which an array of through holes 1339 is provided in a substrate 1316, the artificial dielectric matching elements 1320 can be formed in pairs as part of artificial dielectric matching components 1335. Each artificial dielectric matching element 620 or 1320 can include a closed base portion 905 or 1305 and an open distal portion 909 or 1309. A diameter of an interior volume 913 or 1313 proximate to the base portion 905 or 1305 (i.e. of a first interior volume portion 917 or 1317) can be smaller than a diameter of the interior volume 913 or 1313 at the open distal portion 909 or 1309 (i.e. of a second interior volume portion 925 or 1325). The outer diameter, height, and inner diameter or diameters of each artificial dielectric matching element 620 or 1320 is based on desired the pass band and stop band of the frequency selective structure 604 or 1304. In accordance with embodiments of the present disclosure, each artificial dielectric matching element 620 is formed as a unitary element or structure from a non-conductive material having any dielectric constant. In accordance with embodiments incorporating a thick frequency selective surface 1312, each artificial dielectric matching element 1320 can formed as one of a pair of artificial dielectric matching elements 1320 joined to one another by a connecting section 1337. As examples, but without limitation, the artificial dielectric matching elements 620 or 1320 can be formed by molding, machining, or using additive manufacturing processes. In accordance with further embodiments of the present disclosure, the number of provided artificial dielectric matching elements 620 or 1320 included in the frequency selective structure 604 or 1304 is equal to the number of unit cells 808 of the frequency selective surface layers 612 or the number of through holes 1339 in the thick frequency selective surface 1312.

Artificial dielectric matching layers 608 or 1308 are then formed by connecting the artificial dielectric matching elements 620 or 1320 to the frequency selective surface layer 612 or thick frequency selective surface 1312 (step 1612). For example, one artificial dielectric matching element 620 can be disposed on or adjacent to each unit cell 808 of the frequency selective surface layers 612. More particularly, the artificial dielectric matching elements 620 are disposed on or adjacent to sides of the frequency selective surface layers 612 opposite the sides of those frequency selective surface layers 612 that are facing the substrate 616 (in this example a dielectric layer). The dielectric matching elements 620 can be directly bonded or otherwise attached to an area of a corresponding unit cell 808 of a frequency selective surface layer 612 in a pick and place operation. In accordance with further embodiments of the present disclosure, an adhesive layer or other intermediate layer or layers can be interposed between the artificial dielectric matching elements 620 and the frequency selective surface layers 612. In such an embodiment, a set or array of artificial dielectric matching elements 620 can be joined to an intermediate layer to form an artificial dielectric matching layer 608, and that dielectric matching layer 608 can then be aligned with a frequency selective surface layer 612 so that each artificial dielectric matching element 620 included in the artificial dielectric matching layer 608 is centered in a corresponding unit cell 808 of the frequency selective surface 612, and the dielectric matching layer 608 can be joined to the frequency selective surface layer 612. Alternatively, an intermediate layer can first be placed on the frequency selective surface layer 612, and the artificial dielectric matching elements 620 can then be interconnected to the intermediate layer. As another example, an artificial dielectric matching component 1335 with a pair of integral artificial dielectric matching elements 1320 joined to one another by a connecting section 1337 can be placed in each through hole 1339 in the thick frequency selective surface 1312. Each artificial dielectric matching component 1335 can be placed such that the included artificial dielectric matching elements 1320 extend the same amount from the nearest surface of the thick frequency selective surface 1312. Moreover, each artificial dielectric matching component 1335 can be bonded, friction fit, or otherwise secured in a corresponding through hole 1339.

A coating 624 or 1324 can then be applied to the artificial dielectric matching layers 608 or 1308, over the artificial dielectric matching elements 620 or 1320, to provide a uniform surface (step 1616). The coating 624 or 1324 can be applied like a paint that is sprayed over the artificial dielectric matching layers 608 or 1308 or as an ablative. In accordance with at least some embodiments of the present disclosure, a coating 624 or 1324 can be applied over one surface of the frequency selective structure 604 or 1304. For example, a coating 624 or 1324 may be applied over a surface of the frequency selective structure 604 or 1304 that will correspond to an exterior of a radome 112, but omitted from a surface of the frequency selective structure 604 or 1304 that will correspond to an interior of the radome 112. In accordance with still other embodiments, a coating 624 or 1324 can be applied across portions of a surface of a frequency selective structure 604 or 1304, rather than across the entire surface. In accordance with still other embodiments, a coating can be omitted entirely. The resulting frequency selective structure 604 or 1304 can then be provided as a planar panel, or as a curved or otherwise formed component, and deployed as a radome or cover 112. The process can then end.

A unitary frequency selective structure 1104 can be formed from a single piece of dielectric material. For example, a unitary frequency selective structure 1104 can be formed by injection molding plastic, such as polycarbonate. As another example, a unitary frequency selective structure 1104 can be 3D printed from PLA or ABS.

Embodiments of the present disclosure can include a single artificial dielectric matching layer 608, 1108, or 1308 on one side of a substrate 616, 1116, or 1316. Embodiments of frequency selective structures 604 and 1304 as disclosed herein can include a single frequency selective surface layer 612 or thick frequency selective surface 1312 and a single artificial dielectric matching layer 608 or 1308. Variations in the configuration of the artificial dielectric matching elements 620, 920, or 1320 within an artificial dielectric matching layer 608, 1108, or 1308 are also possible. For instance, the configuration and/or number of interior volume portions formed in an artificial dielectric matching element 620, 920, or 1320 can be selected based on desired performance characteristics. As another example, the configuration of the artificial dielectric matching elements 620, 920, or 1320 can vary based on location within the frequency selective structure 604, 904, or 1304. In accordance with still other embodiments of the present disclosure, a size of the unit cells 808, a spacing of adjacent artificial dielectric matching elements 620, 920, or 1320, the size of the artificial dielectric matching elements 620, 920, or 1320, or the configuration of the artificial dielectric matching elements 620, 920, or 1320 can vary within a frequency selective structure 604, 904, or 1304.

The foregoing disclosure has been presented for purposes of illustration and description. Further, the description is not intended to limit the disclosure to the form disclosed herein. Consequently, variations and modifications commensurate with the above teachings, within the skill or knowledge of the relevant art, are within the scope of the present disclosure. The embodiments described hereinabove are further intended to explain the best mode presently known of practicing the disclosure and to enable others skilled in the art to utilize the disclosure in such or in other embodiments and with the various modifications required by their particular application or use of the disclosure. It is intended that the appended claims be construed to include alternative embodiments to the extent permitted by the prior art.

What is claimed is:

1. A frequency selective structure, comprising:
a substrate;
a first artificial dielectric matching layer, wherein the first artificial dielectric matching layer is disposed proximate a first side of the substrate, wherein the first artificial dielectric matching layer includes a first plurality of artificial dielectric matching elements, and wherein each artificial dielectric matching element in the first plurality of artificial dielectric matching elements includes:
a closed base portion;
an open distal portion; and
an interior volume, wherein the open distal portion is adjacent an open first end of the interior volume, and wherein the closed base portion is adjacent a closed second end of the interior volume.

2. The frequency selective structure of claim 1, further comprising:
a second artificial dielectric matching layer, wherein the second artificial dielectric matching layer is disposed on a second side of the substrate, wherein the second side of the substrate is opposite the first side of the substrate, wherein the second artificial dielectric matching layer includes a second plurality of artificial dielectric matching elements, and wherein each artificial dielectric matching element in the second plurality of artificial dielectric matching elements includes:
a closed base portion;
an open distal portion; and
an interior volume, wherein the open distal portion is adjacent an open first end of the interior volume, and wherein the closed base portion is adjacent a closed second end of the interior volume.

3. The frequency selective structure of claim 1, wherein the substrate is a dielectric layer, the frequency selective structure further comprising:
a first frequency selective surface layer disposed on a first side of the dielectric layer, wherein the first frequency selective surface layer is disposed between the first artificial dielectric matching layer and the dielectric layer, and wherein the first frequency selective surface layer includes a first plurality of unit cells.

4. The frequency selective structure of claim 3, wherein the unit cells of the first plurality of unit cells are disposed in a first two-dimensional array,
wherein each artificial dielectric matching element of the first plurality of artificial dielectric matching elements is disposed within an area of a corresponding unit cell of the first plurality of unit cells.

5. The frequency selective structure of claim 3, further comprising:
a second frequency selective surface layer disposed on a second side of the dielectric layer, wherein the second side of the dielectric layer is opposite the first side of the dielectric layer, and wherein the second frequency selective surface layer includes a second plurality of unit cells; and
a second artificial dielectric matching layer, wherein the second frequency selective surface layer is between the second artificial dielectric matching layer and the dielectric layer, wherein the second artificial dielectric matching layer includes a second plurality of artificial dielectric matching elements, and wherein each artificial dielectric matching element in the second plurality of artificial dielectric matching elements includes:
a closed base portion;
an open distal portion; and
an interior volume, wherein the open distal portion is adjacent an open first end of the interior volume, and wherein the closed base portion is adjacent a closed second end of the interior volume.

6. The frequency selective structure of claim 5, wherein the unit cells of the first plurality of unit cells are disposed in a first two-dimensional array,
wherein each artificial dielectric matching element of the first plurality of artificial dielectric matching elements is disposed within an area of a corresponding unit cell of the first plurality of unit cells,
wherein the unit cells of the second plurality of unit cells are disposed in a second two-dimensional array, and
wherein each artificial dielectric matching element of the second plurality of artificial dielectric matching elements is disposed within an area of a corresponding unit cell of the second plurality of unit cells.

7. The frequency selective structure of claim 2, wherein each artificial dielectric matching element in the first plurality of artificial dielectric matching elements is coupled to an artificial dielectric matching element in the second plurality of artificial dielectric matching elements by a connecting section to form a plurality of artificial dielectric matching components,
wherein the substrate is a conductive material having an array of through holes, and
wherein the connecting section of each of the artificial dielectric matching components is disposed in one of the through holes.

8. The frequency selective structure of claim 1, wherein each of the artificial dielectric matching elements has a cylindrical exterior form.

9. The frequency selective structure of claim 1, wherein each of the artificial dielectric matching elements has a cylindrical interior volume.

10. The frequency selective structure of claim 1, wherein the interior volume includes first and second interior volume portions.

11. The frequency selective structure of claim 10, wherein the first interior volume portion has a first diameter and is proximate to the closed base portion, and wherein the second interior volume portion has a second diameter and is proximate to the open distal portion.

12. The frequency selective structure of claim 11, wherein the first diameter is smaller than the second diameter.

13. The frequency selective structure of claim 1, further comprising:
a coating disposed over the artificial dielectric matching elements of the first artificial dielectric matching layer.

14. The frequency selective structure of claim 1, wherein a dielectric constant of a material of the artificial dielectric matching elements is from 1.4 to 4.0.

15. The frequency selective structure of claim 1, wherein the frequency selective structure is included in a radome.

16. A method for forming a frequency selective structure, comprising:
providing a first plurality of artificial dielectric matching elements, wherein each artificial dielectric matching element in the first plurality of dielectric matching elements includes:
a closed base portion; and
an open distal portion; and
disposing the first plurality of artificial dielectric matching elements on or adjacent a first surface of a substrate.

17. The method of claim 16, further comprising:
providing a second plurality of artificial dielectric matching elements, wherein each artificial dielectric matching element in the second plurality of dielectric matching elements includes:
a closed base portion; and
an open distal portion; and
disposing the second plurality of artificial dielectric matching elements on or adjacent a second surface of a substrate, wherein the second surface of the substrate is opposite the first surface of the substrate.

18. The method of claim 16, wherein the first plurality of artificial dielectric matching elements are disposed on or adjacent the first surface of the substrate using a pick and place operation.

19. The method of claim 16, further comprising:
disposing a coating over the first plurality of artificial dielectric matching elements.

20. A radome, comprising:
a frequency selective structure, including:
a substrate;
an artificial dielectric matching layer, wherein the artificial dielectric matching layer includes a plurality of artificial dielectric matching elements, and
wherein each of the artificial dielectric matching elements includes:
a closed base portion, wherein the closed base portion is disposed on or adjacent to a first surface of the substrate;
an open distal portion; and
an interior volume.
